(19) United States
(12) Patent Application Publication
(10) Pub. No.: US 2005/0006804 A1
(43) Pub. Date: Jan. 13, 2005

(54) Extrusion apparatus and method and extruded foam article

(76) Inventor: Steven Hartman, Brampton (CA)

Correspondence Address: DOWELL & DOWELL PC, 2111 Eisenhower Ave., Suite 406, Alexandria, VA, 22314, US

(21) Appl. No.: 10/614,292

(22) Filed: Jul. 8, 2003

(51) Int. Cl. B29C 44/20; B29C 47/06

(52) U.S. Cl. 264/45.9; 264/173.12; 264/173.18; 425/133.1; 425/382.3

(57) ABSTRACT

An apparatus and method for forming an extruded foam article is disclosed. In an embodiment, a first foam material may be urged through an extrusion channel, and a first coating material may be fed to an applicator in communication with the extrusion channel to apply a visible coating on a region of the outer surface of the foam material. The region is a fraction of a perimeter of the outer surface of the first foam material. In an embodiment, the applicator may be rotated relative to the first foam material to impart a visible helical band on the extruded foam article.

### FIELD OF THE INVENTION

The present invention relates to an extrusion apparatus and method, and more particularly to an apparatus for forming extruded foam articles having a visual surface characteristics, and method.

### BACKGROUND OF THE INVENTION

Extruded foam articles, made from materials such as polyolefin foam, are used in various applications. Such foam articles are for example often used for pipe insulation, as packing material, as components of children's furniture, as protective covers, or as floating toys for use in swimming pools.

In many of these applications, the appearance of the outer surface of the foam impacts the overall attractiveness of the foam article, and thus its value to a consumer. This is particularly acute with toys, protective covers, and furniture, for which purchase decisions are based almost exclusively on the appearance of the article. To this end, U.S. Pat. No. 6,183,673, for example, discloses a process for forming a surface coating or skin on an extruded foam article. The coating may be coloured, allowing the formed article to have a desired uniform colour different from the colour of the underlying foam.

Although attractive, articles having this single colour still provide limited variety and choice to consumers. Although new colours may be periodically introduced, a mere change in colour is typically insufficient to energize consumer interest. Greater variations in appearance may, of course, be achieved by applying aesthetic features on the article by hand. This, however, is labour intensive and ultimately costly.

Clearly then, a new method and apparatus for forming an extruded foam article and inexpensively imparting a desired visual characteristic on the surface of the article is desirable.

### SUMMARY OF THE INVENTION

The present invention provides an apparatus and method for imparting a desired visual characteristic on the outer surface of an article, and the article formed thereby.

In accordance with a first aspect of the invention, there is provided a method of extruding a foam article, comprising: urging a first foam material to an extrusion channel, said first foam material having an outer surface within said extrusion channel; feeding a first coating material to an applicator in communication with said extrusion channel to apply a visible coating on a region of said outer surface of said first foam material within said extrusion channel, said region occupying a fraction of a perimeter of said outer surface.

In an embodiment, the method may further comprise rotating said application relative to said foam material about an axis parallel to the direction of travel of said first foam material through said extrusion channel proximate said applicator, thereby imparting a visible helical bank on said extruded article.

In another aspect of the invention, there is provided an extruded foam article formed in accordance with the method as recited above.

In another aspect of the invention, there is provided a flotation aid formed in accordance with the method as recited above.

In another aspect of the invention, there is provided an extrusion apparatus, comprising: a main die body having a first extrusion passage for allowing a flow of a first foam material to flow therethrough; a rotary die body rotatably mounted to said main die body, said rotary die body having a rotary applicator aligned with said first extrusion passage of said main body; a secondary supply channel in flow communication with said applicator, to provide a continuous flow of a first coating material to said applicator, as said first foam material flows through said rotary applicator.

This and other aspects of the invention will become apparent through the illustrative figures and accompanying description provided below.

### BRIEF DESCRIPTION OF THE DRAWINGS

In the figures which illustrate example embodiments of this invention:

FIG. 1 is a partial cross-section of an extrusion apparatus exemplary of an embodiment of the present invention;

FIG. 2 is a bottom view of the extrusion apparatus of FIG. 1;

FIG. 3 is a perspective view of a bearing plate in the extrusion apparatus of FIG. 1;

FIG. 4 is a perspective view of a rotary die body in the extrusion apparatus of FIG. 1;

FIG. 5 is a perspective view of a die head of the apparatus of FIG. 1;

FIG. 6 is a perspective view of an article formed with the apparatus of FIG. 1;

FIG. 7A and FIG. 7B illustrate the extrusion apparatus of FIG. 1, in operation; and

FIG. 8 illustrates an alternative embodiment of the rotary die body of FIG. 4.

### DETAILED DESCRIPTION

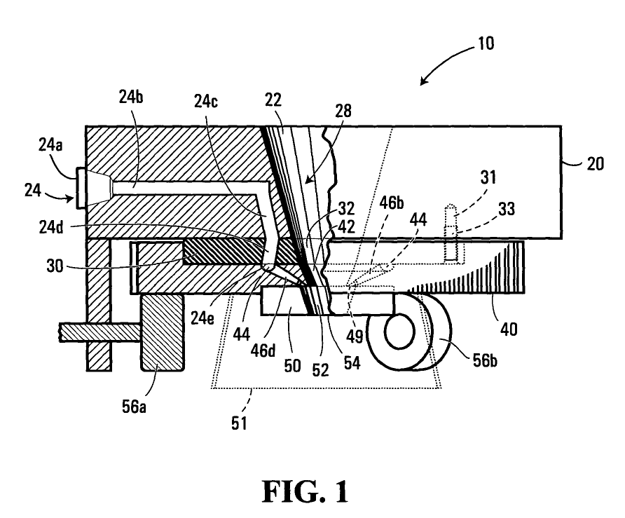

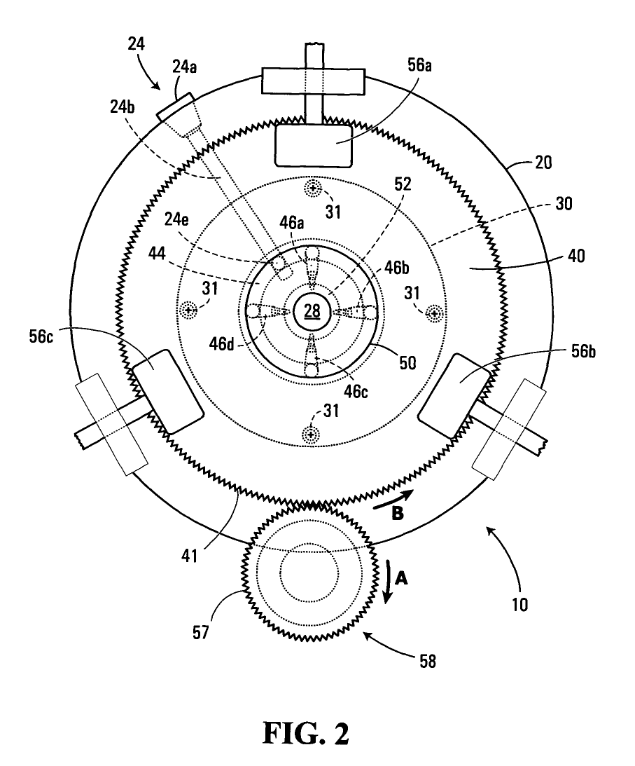

FIGS. 1 and 2 illustrate an extrusion apparatus 10 exemplary of an embodiment of the present invention. As will become apparent, extrusion apparatus 10 may be used to form an extruded article, such as the example extruded article 12 depicted in FIG. 6.

Extrusion apparatus 10 includes a main die body 20, a bearing plate 30, a rotary die body 40, a die head 50, and a protective cup guard 51.

Main die body 20 includes an extrusion passage 22 which allows a first foam material, such as foams of polyolefins, EVAs (ethyl vinyl acetates), polypropylene, and any other foamable thermoplastic polymer to be urged therethrough. Additionally, main die body 20 further includes a secondary supply channel 24. Secondary supply channel 24 allows a flow of a coating material to impart a coating on the extruded primary foam as it is being extruded. Secondary supply channel 24 includes an inlet 24a, a horizontal channel section 24b, and an angled channel section 24c. Angled channel section 24c is in fluid communication with a second angled channel section 24d, which is formed in bearing plate 30. Outlet of the secondary supply channel 24 is shown at 24e. The general shape of secondary supply channel 24 is illustrative, and it will be appreciated that many different shapes are possible.

Bearing plate 30 is mounted to main die body 20 by, for example, a mounting screw 31 which passes through a mounting hole 33 provided in the bearing plate 30.

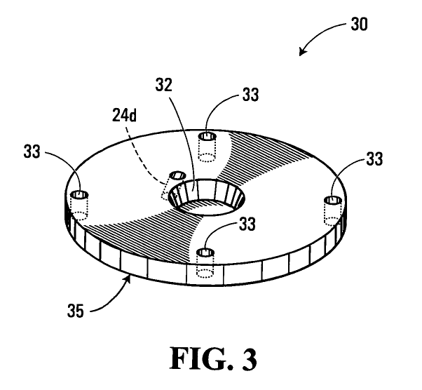

FIG. 3 is a perspective view of an example bearing plate 30. As illustrated, bearing plate 30 includes a further mounting screws 31 that is axially aligned with the mounting screws 22 in main die body 20 (as best viewed in FIG. 1). A plurality of mounting holes 33 may be provided at suitable locations to secure the bearing plate 30 onto the main die body 20. Example bearing plate 30 has an orifice 24d which forms a section of secondary supply channel 24.

Rotary die body 40 (FIG. 1) rotatably engages bearing plate 30. A plurality of cam rollers 56a, 56b, 56c (FIG. 2) provide a constant biasing force which keeps the rotary die body 40 continuously engaged against the bearing plate 30. For clarity of illustration cam roller 56c is not shown in FIG. 1. Rotary die body 40 may be rotated about its central axis by a drive gear 58 engaging the rotary die body 40. For example, rotary die body 40 may be provided with gear teeth 41 for engaging corresponding gear teeth 57 on the drive gear 58. Alternatively, rotary die body 40 may be rotated by a gear arrangement on the rollers 56a-56c, or by a belt around the rotary die body 40. Various other ways of rotating the rotary die body 40 will be apparent to those skilled in the art. As further illustrated, rotary die body 40 includes an additional extrusion passage 42.

A protective cup guard 51 (FIG. 1) may be provided on the rotary die body 40 to prevent an expanding extruded article from accidentally contacting the cam rollers 56a, 56b, 56c. Protective cup guard 51 is not shown in FIG. 2.

Extrusion die 50 may be provided with a mounting hole 53 to mount extrusion die 50 onto rotary die body 40 with a fastener, such as a screw (not shown). Extrusion die 50 includes a further extrusion passage 52.

The central axes of extrusion passage 42; extrusion passage 22 in main die body 20; extrusion passage 32 in the bearing plate 30; and extrusion passage 52 in extrusion die 50, are axially aligned and combine to form an extrusion channel 28. Extrusion channel 28 provides a passage through extrusion apparatus 10 for the first foam material, which is extruded at die egress 54 and forms the main body of an extruded foam article. In an embodiment, each extrusion passage 22, 32, 42, 52 may have generally inwardly tapering walls leading towards the die egress 54.

Secondary supply channel 24 feeds an annular reservoir 44, as best viewed in FIG. 1. Annular reservoir 44 is, in turn, in fluid communication with feed channels 46 in rotary die body 40. In the depicted embodiment, four feed channels 46 discharge into extrusion passage 52 between the egress of extrusion passage 42 of the rotary die body 40 and the ingress of extrusion passage 52 of the extrusion die 50.

Feed channels 46a-46d (individually and collectively 46—best viewed in FIG. 2) are positioned at equal angular spacings about the central axis of extrusion channel 28 to provide fluid communication between the annular reservoir 44 and the extrusion passage 52 in the extrusion die 50 (FIG. 1). As will become apparent, the number and spacing of feed channels 46 ultimately govern the appearance of the coating of an extruded article. The number and spacing may be readily varied as desired.

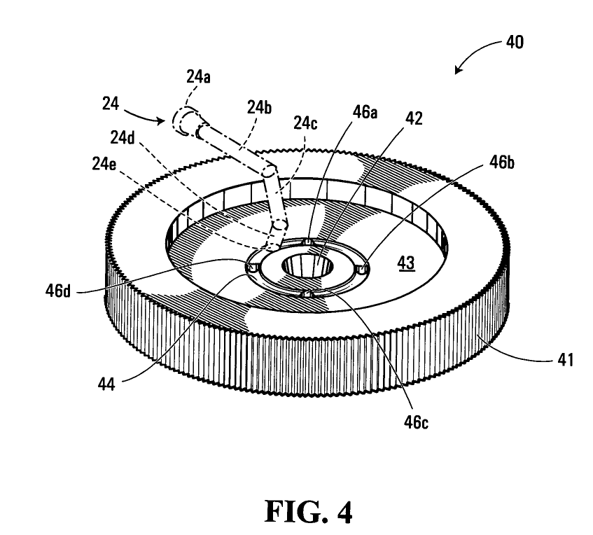

FIG. 4 is a perspective view of rotary die body 40. As illustrated, die body 40 is generally disc shaped and includes a circular recess 43 axially aligned with the central axis of the rotary die body 40. Recess 43 is appropriately dimensioned, in depth and in diameter, to receive bearing plate 30 (as shown in FIG. 1). Annular reservoir 44 is nested within recess 43. Inlets to feed channels 46 are again illustrated.

When bearing plate 30 and rotary die body 40 are engaged, as shown in FIG. 1 bearing surface 35 of bearing plate 30 abuts rotary die body 40, and thereby encloses the annular reservoir 44. Outlet 24e of the secondary supply channel 24 is aligned with the annular reservoir 44 so that secondary supply channel 24 maintains continuous fluid communication with the annular reservoir 44 as rotary die body 40 rotates relative to main die body 20.

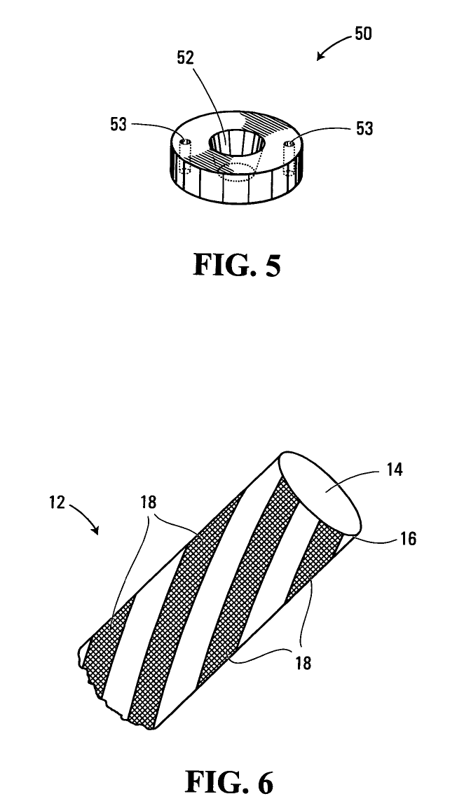

Extrusion die 50 is more particularly illustrated in FIG. 5. As shown, extrusion die 50 is generally disc shaped, and exemplified extrusion passage 52 is generally funnel-shaped: the wall of the extrusion passage 52 tapers as the passage 52 extends from the ingress of the passage to egress 54 of extrusion die 50. As will become apparent, extrusion passage 52 of extrusion die 50 acts as an applicator, to apply a coating to the outer surface of the article 12 (FIG. 6) as it is being extruded.

FIG. 6 depicts an illustrative extruded article 12 that may be formed by the extrusion apparatus 10 of FIG. 1. As illustrated, extruded article 12 may include a core or main body 14 having an outer surface 16. In the depicted embodiment, outer surface 16 includes a coating taking the form of several helical bands 18. Each band 18 has a colour that contrasts an area of the surface of the article adjacent the bands 18. In the illustrated embodiment, extruded article 12 is formed having four equally spaced helical bands 18. As shown, the helical bands 18 occupy a region representing a fraction of a perimeter of the outer surface 16.

As will become apparent, the helical band or bands 18 may be imparted on the surface of the main body 14 by extruding a first foam material through the extrusion apparatus 10, while applying a coating material forming the band 18 by way of extrusion die 50 that rotates relative to the main die body 20, and extrusion channel 28. The helical bands 18 provide an attractive visual characteristic on the surface of the extruded article 12, and the main body 14 made of a foam material provides buoyancy, allowing the extruded article 12 to be used as a swimming aid.

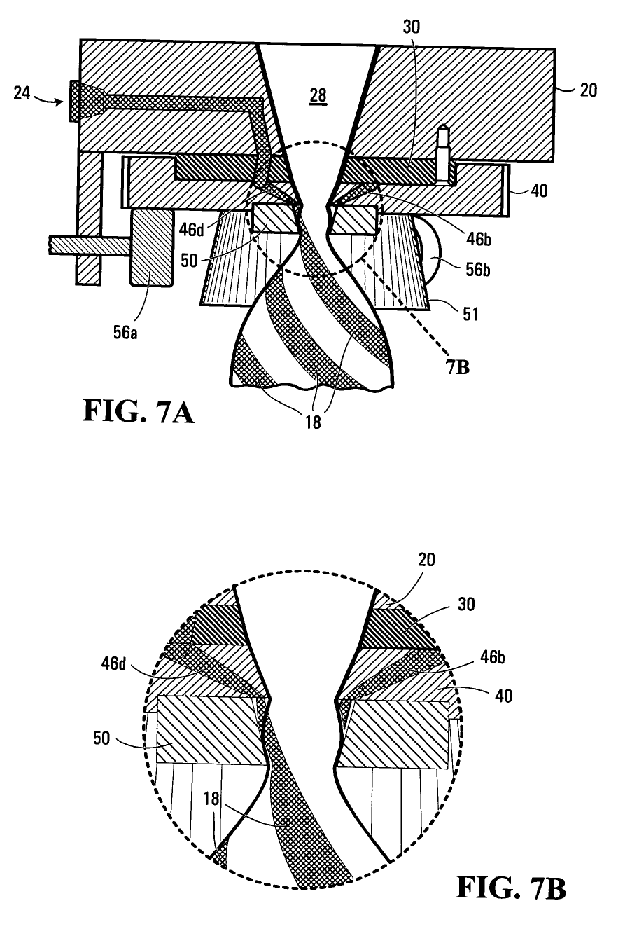

In operation, a first foam material is fed into extrusion channel 28. The first foam material is preferably a mixture of a suitable extrudable material, such as polyolefin, and a foaming agent for expanding the polyolefin material upon extrusion. Within extrusion channel 28, the first foam material begins to assume a shape having a relatively uniform cross-section, corresponding to that of the extrusion channel. At the same time, the secondary supply channel 24 is fed with a coating material, preferably having a colour that contrasts that of the first foam material. Preferably the coating material is compatible with the first foam material, but coloured. Colouring may be achieved by way of a dye, or the like. The flow of the first foam material and the coating material to form article 14 is illustrated in FIG. 7A and FIG. 7B.

The first foam material flows through passages 22, 32, and 42 and enters rotating passage 52.

Rotary die body 40 (and thus extrusion die 50 and extrusion passage 52) are rotated relative to the main die body 20. Specifically, rotation of the drive gear 58 in direction A by a motor drive (FIG. 2) causes the rotary die body 40 to rotate in direction B, as illustrated. The wall of passage 52 rotates about and relative to the first foam material, being extruded through channel 28.

At the same time, the coating material enters passage 52 from feed channels 46. The coating material flows from the point of exit of each channel 46 along the interior wall of passage 52, and rotates with the wall of passage 52. As the coating material flows downward along the wall of passage 52, it disperses circumferentially along the wall of passage 52. As a result, the coating material covers an area larger than the width of the outlet of each channel 46. The coating material then makes contact with the surface of the first foam material, in passage 52.

As a result, the region of application of each feed channel 46 rotates about the central axis of passages 52, and extrusion channel 28. This relative rotation causes the coating material to come into contact with the surface of the first foam material within extrusion channel 28, at varying angular locations about the axis of extrusion channel 28, proximate the region of application as the first foam material moves along the axis of the extrusion channel 28. As applied, the coating from each feed channel 46 colors less than the entire outer perimeter of the main body 14 in passage 52. As a result, the coating material takes the form of helical bands 18, occupying a region representing a fraction of a perimeter of the outer surface 16 of the extruded article 12, as illustrated in FIG. 7A. Each feed channel 46 forms a single helical band 18 on the extruded article 14. The number of bands 18 and the appearance of article 12 may thus be varied by varying the number and spacing of the feed channels 46 and the speed of rotation of the rotary die body 40.

It will be appreciated that, in an embodiment, of the rotary die body 40 is not rotating, then bands will be formed on the extrude article 14.

The combination of the first foam material and coating material exits extrusion apparatus 10 at egress 54 of extrusion die 50. As this combination exits, it expands uniformly due to the active foaming agent mixed in the first foam material. The degree of expansion may be controlled by, for example, selection of the foaming agent, control of the amount of foaming agent used, the temperature of the combination, and the relative drop in pressure once the combination exits egress 54. Protective cup guard 51 prevents the extruded, expanding article 12 from accidentally contacting rollers 56. Conveniently, the coating material may be formed from material that has suitable expansion characteristics, so that the coating material expands at the same rate as the first foam material. This retains the helical band appearance on the outer surface 16 of the main foam body 14 as it expands substantially. Moreover, the coating material remains on or near the surface of the main foam body 14. Typically, the first foam material may expand in volume by a factor of 10 to 50 with the coating material expanding correspondingly on the surface of the first foam material. As the combination cools, it hardens in its extruded form. Conveniently, if the coating material is of the same material as the first foam material, the texture of the outer surface 16 of the formed article 14 is generally uniform. As well, as the coating material is only applied to the outer surface 16, the quantity of coating material required is only a small fraction of the quantity of first foam material used to form article 14.

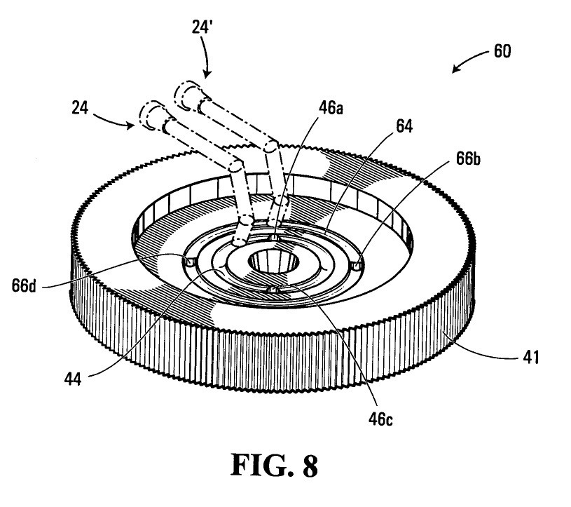

As should now be appreciated, the apparatus of FIG. 1 may easily be modified to allow application of helical bands of multiple colours to an extruded article. For example, FIG. 8 shows an alternative embodiment of rotary die body 40. In this alternative embodiment, a second annular reservoir 64 is shown formed in the recess 43. As with the first annular reservoir 44, the second annular reservoir 64 is axially aligned with the axis of rotation of the rotary die body 40. In this alternative embodiment, two feed channels 46a, 46c remain in the inner annular reservoir 44. However, two new feed channels 66a and 66b are now shown in the outer annular reservoir 64, spaced approximately 90 degrees apart from feed channels 46a, and 46c. Reservoir 64 may now be fed by a second secondary supply channel 24′, that could extend through body 20, that may provide a coating that may be visually distinct from both the first foam material, and the coating material provided by way of the first secondary supply channel 24 (FIG. 1).

As should also be appreciated, instead of using colored dyes, it may be possible to add other appealing visual characteristics. For example, fine reflective particles of various colors (e.g. gold, silver, green, red, blue) may add a glittering or sparkling helical band appearance. It will be apparent to those skilled in the art that numerous other appealing visual characteristics may be imparted on the outer surface 16 of an extruded article 12 in the manner described herein.

Similarly, although the cross section of passages 22, 32, 42 and 52 have been illustrated as circular, a variety of other cross-sections are possible. For example, the cross-section of passage 52 could be square, rectangular, oval or a variety of other shapes, thereby shaping an extruded article.

Additionally, while the bearing plate 30 may be provided to avoid wear on the main die body 20, it will be appreciated that, in an alternative embodiment, a bearing surface for engaging the rotary die body 40 may be formed directly on the main die body 20 itself. While the extrusion die 50 in FIG. 1a is shown as a separate piece attached to the rotary die body 40, it will be appreciated that, in an alternative embodiment, such a extrusion die 50 may be formed integrally with the rotary die body 40. Various other modifications, including non-planar engagement (e.g. a shallow conical engagement) between any of the components (e.g. between the bearing plate 30 and the rotary die body 40), will also be apparent to those skilled in the art. Also, while the annular reservoir 44 is shown formed entirely in the rotary die body 40, it will be appreciated that in an alternative embodiment a portion of, or all of, the annular reservoir 44 may be formed on the bearing plate 30.

The exemplified extrusion apparatus are illustrative and are not to be construed as limiting the invention to the specific embodiment shown. Other modifications will be apparent to those skilled in the art and, therefore, the invention is defined in the following claims.

1. A method of extruding a foam article, comprising:
urging a first foam material to an extrusion channel, said first foam material having an outer surface within said extrusion channel;
feeding a first coating material to an applicator in communication with said extrusion channel to apply a visible coating on a region of said outer surface of said first foam material within said extrusion channel, said region occupying a fraction of a perimeter of said outer surface.

2. The method of claim 1, further comprising rotating said applicator relative to said first foam material about an axis parallel to the direction of travel of said first foam material through said extrusion channel proximate said applicator, thereby imparting a visible helical band on said extruded foam article.

3. The method of claim 2, wherein said applicator forms part of an extrusion die at least partially defining said extrusion channel, and said rotating comprises rotating said extrusion die relative to said first foam material.

4. The method of claim 3, further comprising feeding said first coating material to said applicator as a plurality of spaced flows, each flow imparting a visible helical band on said extruded foam article.

5. The method of claim 3, further comprising feeding a second coating material to said applicator, said second coating material being visually distinct from both said first foam material and said first coating material, said second coating material imparting a visible helical band visually distinct from said visible helical band imparted by said first coating material.

6. The method of claim 2, further comprising urging said first foam material through an extrusion outlet, and allowing said first foam material and said coating material to expand, wherein said coating material expands with said first foam material to remain proximate a surface of said first foam material.

7. The method of claim 6, wherein said first foam material is foamable thermoplastic polymer, and said first coating material is a compatible material of a different color.

8. The method of claim 7, wherein said foamable thermoplastic polymer expands by a factor of 10 to 50 as it exits said extrusion outlet.

9. An extruded foam article formed in accordance with the method of claim 2.

10. A floatation aid formed in accordance with the method of claim 2.

11. An extrusion apparatus, comprising:
a main die body having a first extrusion passage for allowing a flow of a first foam material to flow therethrough;
a rotary die body rotatably mounted to said main die body, said rotary die body having a rotary applicator aligned with said first extrusion passage of said main body;
a secondary supply channel in flow communication with said applicator, to provide a continuous flow of a first coating material to said applicator, as said first foam material flows through said rotary applicator.

12. The extrusion apparatus of claim 11, wherein, said secondary supply channel comprises:
a secondary supply channel section formed in said main die body;
an annular reservoir formed between said main die body and said rotary die body, said annular reservoir providing continuous flow communication to said secondary supply channel section in said main die body, as said rotary die body rotates relative to said main die body;
at least one feed channel in fluid communication with said annular reservoir, and providing a continuous flow of said coating material to said rotary applicator.

13. The extrusion apparatus of claim 12, comprising a plurality of spaced feed channels each providing a continuous flow of said coating material to said rotary applicator.

14. The extrusion apparatus of claim 13, wherein said rotary applicator has a generally decreasing cross-section towards an extrusion outlet.

15. The extrusion apparatus of claim 11, comprising a bearing plate between said main die body and said rotating die body, said bearing plate having an extrusion passage aligned with said extrusion passage of said main die body, and an extrusion orifice forming a section of said secondary supply channel.

16. The extrusion apparatus of claim 12, further comprising a second secondary supply channel providing a continuous flow of a second coating material to said rotary applicator, said secondary supply channel comprising:
a secondary supply channel section formed in said main die body;
a second annular reservoir formed between said main die body and said rotary die body, said second annular reservoir providing continuous flow communication to said second secondary supply channel section in said main die body, as said rotary die body rotates relative to said main die body;
at least one feed channel in flow communication with said second annular reservoir, and providing a continuous flow of said second coating material to said rotary applicator.
